(19) United States
(12) Patent Application Publication
(10) Pub. No.: US 2026/0276104 A1
(43) Pub. Date: Sep. 17, 2026

(54) Tire Deflation Device

(71) Applicant: Daniel Frerichs, Arlington, WA (US)

(72) Inventor: Daniel Frerichs, Arlington, WA (US)

(21) Appl. No.: 19/541,235

(22) Filed: Feb. 16, 2026

Related U.S. Application Data
(60) Provisional application No. 63/760,042, filed on Feb. 18, 2025.

(51) Int. Cl. F16K 51/00; F16K 24/04

(52) U.S. Cl. CPC F16K 51/00; F16K 24/04

(57) ABSTRACT

A tactical tire deflation device has a cylindrical volume closed at one end by a cap, and defined by a plurality of resilient wall segments. The segments each have inwardly disposed friction ridges, and each segment is spaced from the others by a slot running longitudinally in the cylindrical volume.

### CROSS REFERENCE TO RELATED APPLICATIONS

This application claims priority to U.S. Provisional Patent application 63/760,042, filed Feb. 18, 2025 which is hereby incorporated by this reference as if fully set forth herein.

### TECHNICAL FIELD

This disclosure relates to technical tire deflation devices; more particularly, it relates to method and apparatus for deflating a tire quickly without needing to be threaded on.

### BACKGROUND

It is sometimes necessary, in the line of duty, for an officer of the law to precautionarily deflate one or more of the tires of a vehicle that has been stopped by the officer so as to hinder or prevent evasive drive-away or escape. Conventionally, this is accomplished with a Schrader valve core removal device to remove, or loosen, the tire valve stem core, or by puncturing the tire, or by screwing on a conventional deflation cap.

Such a conventional tool has inner threads to match the standard outer threads of the valve stem. A known threaded deflation tool may only be applied by threading it on and later removed by unscrewing it. This procedure is made more difficult in the dark or in inclement weather, is difficult to do with a gloved hand, and takes up too much time for the officer who, in such situations, may be susceptible to the unwanted attention of the operator of the stopped vehicle. Time spent stooping to thread on a device also exposes the officer for a longer time to the hazards of passing traffic.

What is needed is a tactical deflation device that can be applied quickly, decisvely and without careful visualization and also without further attention to, or manipultion of, the device by the officer after it is applied.

### DISCLOSURE

The disclosed device uniquely provides these features, and is pushed onto the valve stem of the tire by hand, not screwed-on. A pin inside the device depresses the valve stem core pin which immediately starts releasing air through the side vents (for example, through the slots as illustrated herein). If removal of the device is desired after or during tire deflation, it can either be simply pulled off (as the device walls and inner ridges will flex sufficiently to allow this to happen, or it can even be “unscrewed” from the valve stem to extend the usable life of the device. (Though the device advantageously has no internal thread itself, the resilient gripping action of the device walls and the inner ridges will facilitate molding themselves somewhat to the valve threads and thereby allow a kind of ‘unscrewing’ action.)

The release of air thus effected by the disclosed device is much quieter than tire puncture or removing the Schrader valve core, and therefore less likely to alert the suspect-driver.

The device is desirably fashioned from a semi-rigid, sufficiently flexible plastic, with thickness dimensions which, in conjunction with each other (device wall flexion and wall thickness) enable the device, when pressed on to the stem by the user, to firmly grip the stem so it is not blown off by the escaping air nor easily jostled loose during an escape attempt.

Advantages of the device compared to conventional tactical tire deflation, including Schrader valve core removal are that tests show that it takes less than 1 second to apply and start tire deflation. The officer is exposed for less time to hazards of crouching by tire. It requires almost no dexterity as there is no threading or finger manipulation required and it can be done with heavy gloves on. It is much easier to apply under stress, or under low visibility or bad environmental conditions. And the release of air is much quieter, less likely to alert the driver.

The push fit of the device on the valve stem will remain on the tire and continue to deflate if the vehicle drives away.

The advantageously semi-flexible wall(s) of the device inner chamber enable expansion, or spreading out, of the inner chamber diameter to enable the device to be pushed onto the valve stem, but then also continues to produce inward (gripping) pressure on the valve stem outer surface, thus increasing friction and retention onto the valve stem.

The slots separating the several wall segments of the device, serve also as paths for air to escape from the valve stem through the device while it is on the valve stem. Alternatively, other vents may include holes or gaps in the sidewall of the device. The device inner chamber has retention ridges (or, optionally, even threads) that grip the external threads of the valve stem. These gripping ridges may include such structures as teeth, barbs, threads, lips, ridges, or other inwardly protruding structures, either continous or intermittent.

Where the device walls are slotted or slitted, other wall flexibility characteristics (wall thickness, wall elasticity and the like) are desirably adjustable during device manufacture for somewhat greater or lesser rigidity (while still remaining resiliently flexible), since the slots or slits themselves function to aid in wall segment flexure.

In a particular tire deflation device there is a cylindrical volume that has a cylinder axis and is closed at one end by a cap, with a pin interengaged in the cap and generally coaxial with the cylinder axis. The cylindrical volume is enclosed by a plurality of wall segments, and a plurality of the segments each have inwardly disposed a plurality of friction ridges, each segment spaced from one another by a slot running longitudinally in the cylindrical volume.

In some devices at least one of the wall segments advantageously has a flexure feature. The flexure feature is an elasticity in the material of the wall segment that allows the wall segment to be resiliently spread in a direction generally away from the cylinder axis. In other devices, the friction ridges themselves make up all or part of the flexure feature.

While some devices may have some internal threading, it is by no means required that devices be threaded at all.

One desirable and disclosed method of deflating a tire is to press a device having a cylindrical volume and equipped with internal friction ridges onto a Schrader valve stem, whereby the device slides readily onto the stem, over its threads, but resists removal or loss of the cap by a flexible gripping action of the ridges against the stem threads, such that an internal pin presses against the valve core pin of the Schrader valve to allow air to escape.

In general, disclosed devices are designed to be a push fit over a Schrader-type tire inflation valve stem, and resilient ridges that deform to slide over the valve threads (but then rebound upon stopping the push-on movement) to engage and or fill at least to some extent the valve threads and thus resist being pulled off, knocked off, or blown off by escaping air.

### BRIEF DESCRIPTION OF THE DRAWINGS

FIG. 1 is a schematic perspective view of disclosed device.

FIG. 2 is a sectional elevation of the disclosed device.

### DETAILED DESCRIPTION

Turning now to the drawings, the disclosed device is described by reference to the numerals of the drawing figures wherein like numbers indicate like parts.

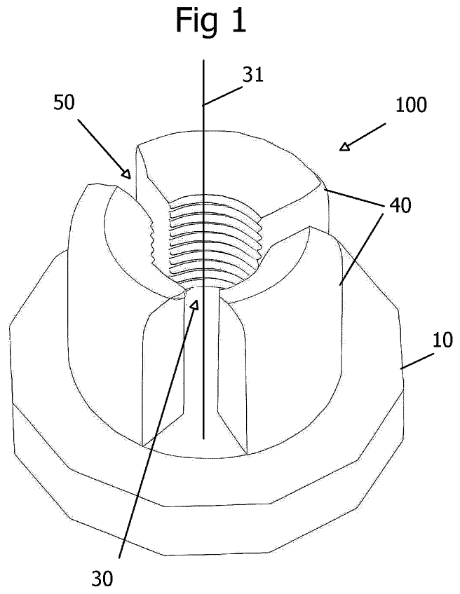

In FIG. 1, deflator device 100 has a roughly cylindrical internal space 30 (with axis 31) surrounded by curved wall segments 40, each segment spaced apart from the others by slots 50. The cylindrical space of device 100 is closed at one end by cap 10.

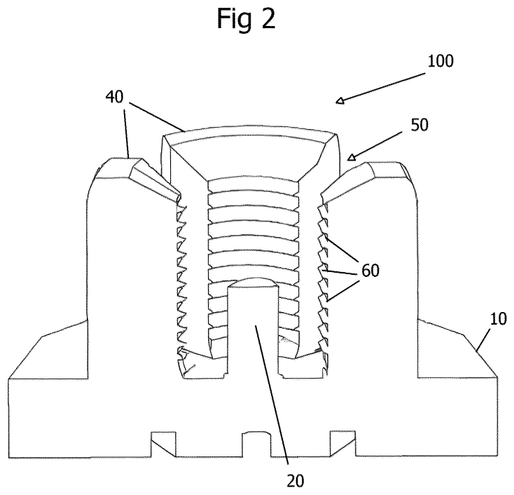

In FIG. 2, deflator device 100 has deflator pin 20 engaged within cap 10, with pin 10 central to the cylindrical internal space of the device. In particular, friction ridges 60 generally line the inner surfaces of wall segments 40, enabling a push fit of the device over the threads of the Schrader valve external threads (not shown).

In compliance with the statute, the disclosure is couched in language more or less specific as to structural features. It is to be understood, however, that it is not limited to the specific features shown, since the means and construction shown comprise particular forms of effecting this disclosure. The invention is, therefore, claimed in any of its forms or modifications within the legitimate and valid scope of the appended claims, appropriately interpreted in accordance with the doctrine of equivalents.

I claim:

1. A tire deflation device comprising a cylindrical volume, the volume having a cylinder axis and closed at one end by a cap, a pin interengaged in the cap and generally coaxial with the cylinder axis, the cylindrical volume enclosed by a plurality of wall segments, a plurality of the segments each having inwardly disposed thereon a plurality of friction ridges, each segment spaced from one another by a slot running longitudinally in the cylindrical volume.

2. The device of claim 1, wherein at least one of the wall segments further comprises a flexure feature.

3. The device of claim 2, wherein the flexure feature is an elasticity in the material of the at least one wall segment that allows the wall segment to be resiliently spread in a direction generally away from the cylinder axis.

4. The device of claim 2, wherein the friction ridges comprise all or part of the flexure feature.

5. The device of claim 1, wherein the flexure feature is further comprised of the plurality of friction ridges.

6. The device of claim 1, wherein the friction ridges are not comprised of helical threads.

7. The device of claim 1, wherein the pin is shorter than the wall segments.

8. A method of deflating a tire, the method comprising the steps of
pressing a device comprising a cylindrical volume and equipped with internal friction ridges onto a Schrader valve stem, whereby the device slides readily onto the stem, over its threads, but resists removal or loss of the cap by a flexible gripping action of the ridges against the stem threads, such that an internal pin presses against the valve core pin of the Schrader valve to allow air to escape.
